(19) United States
(12) Patent Application Publication
(10) Pub. No.: US 2008/0068587 A1
(43) Pub. Date: Mar. 20, 2008

(54) Surface defect detection method and surface defect inspection apparatus

(75) Inventor: Nobuo Kawasaki, Kanagawa (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Ohara Inc.

(21) Appl. No.: 11/898,760

(22) Filed: Sep. 14, 2007

(30) Foreign Application Priority Data
Sep. 19, 2006 (JP) 2006-253319

(51) Int. Cl. G01N 1/00; G01N 21/47

(52) U.S. Cl. 356/36; 356/446

(57) ABSTRACT

A surface defect detection method and a surface defect inspection apparatus are provided having a function of inspecting only the defects and foreign particles on the surface regardless of whether or not there are internal defects, internal foreign particles, or internal light scattering particles, even if the inspection target material is a transparent or translucent material, or a material containing internal crystals such as crystallized glass. A medium layer having a higher refractive index than that of the inspection target material is provided to be in contact with the inspection target surface of the inspection target material. Inspection light is input from the medium layer side with an incident angle that achieves total reflection on the interface between the medium layer and the inspection target surface, and the reflected light of the inspection light, which is reflected by the inspection target surface, is detected, thereby inspecting for surface defects and foreign particles on the inspection target surface.

This application is based on and claims the benefit of priority from Japanese Patent Application No. 2006-253319, filed on 19 Sep. 2006, the content of which is incorporated herein by reference.

### BACKGROUND OF THE INVENTION

1. Field of the Invention

The present invention relates to a method for detecting surface defects such as scratches, surface pitting, and foreign particles on the surface of a transparent or translucent material such as a glass substrate, and particularly to a surface defect inspection method and a surface defect inspection apparatus having a function of detecting surface defects and foreign particles on a transparent or translucent material by employing total reflection.

2. Related Art

With conventional inspection methods for inspecting the surface of a material, laser light is emitted to the surface of the inspection target material at an angle, and regular reflection light, which is light reflected by the surface of the inspection target material in a regular manner, is detected. Also, known inspection methods include a detection method for detecting foreign particles, scratches, etc., by detecting scattered light from the defects or the foreign particles.

In the detection methods using the regular reflection light, a photoreceptor is disposed in the optical path of the regular reflection light which is generated by regular reflection of the incident inspection light by the inspection target material. With such a method, first, the reflected light is detected with respect to a normal material which is an inspection target material having neither defects nor foreign particles. In a case in which the inspection target material has defects, foreign particles, etc., on the surface thereof, the inspection light is scattered by the defects, foreign particles, etc., which reduces the amount of the reflected light detected by the photoreceptor, thereby detecting the defects, foreign particles, etc. On the other hand, in the detection methods using scattered light, a photoreceptor is disposed at a position other than the optical path of the regular reflection light which is generated by regular reflection of the incident inspection light by the inspection target material. With such an arrangement, if the inspection target material is a normal material having no defects, foreign particles, etc., on the surface thereof, the inspection light is reflected by the inspection target material. Accordingly, in this case, the photoreceptor receives no light. On the other hand, if the inspection target material has defects, foreign particles, etc., the inspection light is scattered by the defects, foreign particles, etc. Accordingly, in this case, the photoreceptor receives light, thereby detecting the defects, foreign particles, etc.

With respect to a transparent or translucent material having neither internal defects nor internal foreign particles, or an opaque material such as a metal, etc., such inspection methods using the propagation light provides a function of detecting defects, foreign particles, etc., on the surface thereof by detecting the intensity of the scattered light generated by way of scattering of the incident inspection light by the defects or the foreign particles, or by way of detecting the reduction in the reflected light. However, if the inspection target material is a transparent or translucent material containing internal defects or internal foreign particles, or if the target material is a translucent material containing internal crystals (scattering particles), such as crystallized glass, the photoreceptor also detects the scattered light scattered from the internal defects, the internal foreign particles, or the internal scattering particles such as the internal crystals, etc. With such an arrangement, there is a problem in that the scattered light scattered from the foreign particles, defects, etc., on the surface of the inspection target material cannot be discriminated from the scattered light scattered from the internal foreign particles, the internal defects, or the internal scattering particles such as the internal crystals, etc. Accordingly, such inspection methods cannot provide inspection results for such materials with sufficient reliability. In particular, if the inspection target material is crystallized glass having internal crystals, the scattered light scattered from the internal crystals contained in the target material interferes with the inspection. Accordingly, in this case, the defects or the foreign particles on the surface of the target material cannot be detected using such conventional inspection methods.

In order to solve such problems, surface inspection methods and surface inspection apparatuses have been proposed, having a function of detecting foreign particles, defects, etc., only on the surface of a material, even if the inspection target material has a transparent or translucent surface (e.g., Patent Documents 1 and 2).

### [Patent Document 1]

Japanese Unexamined Patent Application, First Publication No. Hei 07-110303

### [Patent Document 2]

Japanese Unexamined Patent Application, First Publication No. 2001-228094

### DISCLOSURE OF THE INVENTION

### Problems to be Solved by the Invention

Patent Document 1 discloses a surface inspection method as follows. In this method, light is obliquely emitted toward the surface of the inspection target material, and the intensity of the reflected light is measured. Furthermore, the field of view of the photoreceptor for measuring the intensity of the reflected light is limited so as to shield the scattered light scattered from the internal foreign particles, the internal defects, and the scattering particles (internal crystals), thereby detecting only the defects and the foreign particles on the surface thereof. However, if the inspection target material has internal foreign particles, internal defects, or internal scattered particles (internal crystals) near the surface to be inspected, such a method can encounter a problem of false detection of the surface defects, which is a serious concern. Furthermore, there is a need to limit the field of view of the photoreceptor so as not to detect the scattered light scattered from the interior of the inspection target material, which is troublesome. On the other hand, Patent Document 2 discloses a surface inspection method as follows. In this method, a proximity optical element is disposed on the surface side of a disk substrate, and the incident inspection light is input at a predetermined angle. Furthermore, such an arrangement includes: a first photo-detector for receiving both the scattered light scattered from the defects on the surface of the disk substrate and the scattered light scattered from the interior of the substrate, thereby detecting the light amount thereof; and a second photo-detector for detecting the evanescent light component scattered from the microstructure of the surface. With such an arrangement, the detection value detected by the first photo-detector is corrected based upon the detection value detected by the second photo-detector, thereby identifying the defects on the surface with improved precision. However, with such an arrangement, there is a need to dispose the proximity optical element near the surface of the inspection target material. In addition, there is a need to detect two kinds of light amounts using the two photo-detectors, which is troublesome.

The present invention has been made in view of the aforementioned problems. Accordingly, it is an object of the present invention to provide a surface defect detection method and a surface defect inspection apparatus having a function of detecting only the defects and foreign particles on the surface regardless of whether or not the target material contains internal defects, internal foreign particles, or internal crystals, even if the target material is a transparent or translucent material, or a material having internal crystals such as crystallized glass.

### SUMMARY OF THE INVENTION

Upon the present inventor having thoroughly studied in order to achieve a solution to the aforementioned problem, the present inventor has discovered the following facts, thereby completing the present invention. That is to say, a medium layer having a higher refractive index than that of the inspection target material is provided such that it is in contact with the inspection target surface of the inspection target material. Inspection light is input from the medium layer side with an incident angle that achieves total reflection on the inspection target surface of the inspection target material stored in the medium layer, and the reflected light of the inspection light, which is reflected by the inspection target surface, is detected. With such an arrangement, the incident light does not reach the interior of the material regardless of whether or not the inspection target material is a transparent or translucent material. Thus, such an arrangement provides a function of inspecting defects or particles on the surface regardless of whether or not the inspection target material contains internal defects, internal foreign particles, or internal scattering particles. More specifically, the present invention provides the following arrangements.

The term “reflected light” according to the present invention represents the light including the total reflected light and the scattered light. The term “total reflected light” as used here represents the light obtained as a result of total reflection in which the incident inspection light is totally reflected without refraction at an interface between two different medium layers, or at an interface formed due to the discontinuity of a certain factor. The term “scattered light” as used here represents light propagating in various directions from each hindrance such as a defect, a foreign particle, etc., serving as a scattering center, as a result of scattering in which the inspection light propagating in a single direction is scattered by such hindrances.

According to a first aspect of the present invention, a surface defect detection method includes steps of: providing a medium layer having a higher refractive index than that of an inspection target material to be in contact with the inspection target surface of the inspection target material; inputting incident inspection light from the medium layer side with an incident angle that achieves total reflected light propagation through the medium layer; and detecting reflected light of the inspection light, which is reflected by the inspection target surface, thereby inspecting for surface defects on the inspection target surface.

In the first aspect, the medium layer, which has a higher refractive index than that of the inspection target material, is provided to be in contact with the inspection target surface of the inspection target material. With such an arrangement, when the inspection light is input from the medium layer side with an incident angle which is equal to or larger than the smallest incident angle (which is referred to as “critical angle” hereafter) that achieves total reflection on the inspection target surface, the inspection light does not reach the interior of the inspection target material, and is totally reflected by the interface between the medium layer and the inspection target material, i.e., the inspection target surface. Accordingly, with such an arrangement, the inspection light does not reach the interior of the inspection target material, and accordingly, scattered light due to internal defects, internal foreign particles, or internal light scattering particles such as internal crystals, does not occur, even if the inspection target material contains such internal defects, internal foreign particles, or internal light scattering particles such as internal crystals. Thus, such an arrangement provides a function of detecting only the defects and foreign particles on the surface as described below.

First, a description is provided regarding the propagation of the incident light in a case in which there are no surface defects. In a normal state in which there are neither defects nor foreign particles on the surface of the inspection target material, when the inspection light is input from the medium layer side with an incident angle which is equal to or larger than the critical angle, the light is totally reflected by the inspection target surface, thereby achieving reflected light having the same light amount as that of the inspection light thus input. The reflected light thus totally reflected propagates through the medium layer toward the interface between the medium layer and an air layer. Furthermore, the reflected light thus totally reflected is input from the medium layer side to the interface between the medium layer and the air layer with an incident angle which is equal to or higher than the critical angle that achieves total reflection at the interface between the medium layer and the air layer. Accordingly, the reflected light is totally reflected again by this interface. The reason why the total reflection occurs again on the interface between the medium layer and the air layer is as follows. That is to say, there is a relation between the refractive indices that is represented by an Expression (the refractive index of the medium layer>the refractive index of the inspection target material>the refractive index of the air layer). Accordingly, the critical angle that achieves total reflection on the interface between the medium layer and the air layer is smaller than that on the interface between the medium layer and the inspection target material.

Accordingly, the inspection light input from the medium layer side propagates through the medium layer without escaping therefrom, while being repeatedly totally reflected by the inspection target surface and the interface between the medium layer and the air layer.

On the other hand, in a case in which there are defects or foreign particles on the inspection target surface, a portion of the incident inspection light is scattered by the defects or the like, thereby generating scattering light propagating in various directions. A portion of the scattered light escapes to the air layer above the medium layer, which is dependent upon the scattering angle. On the other hand, the other portion of the scattered light propagates through the medium layer without escaping therefrom, while being repeatedly totally reflected by the interface between the air layer and the medium layer, and the interface between the medium layer and the inspection target material. Furthermore, the other portion of the incident inspection light, which has not scattered, is totally reflected, thereby achieving total reflected light propagating the medium layer. Accordingly, in a case in which there are defects, etc. on the inspection target surface, the light amount of the total reflected light obtained in the optical path is smaller than that obtained in a case in which there are no defects or the like on the inspection target surface.

With such an arrangement, the photo-receiving means detects: the amount of the total reflected light obtained in the optical path; the amount of the scattered light propagating in the medium layer, which is detected at a position other than the optical path of the total reflected light; or the amount of the scattered light escaping from the medium layer to the air layer above the medium layer, thereby detecting whether or not there are defects or foreign particles on the surface of the inspection target material.

Furthermore, with the present invention, the inspection light does not reach the interior of the inspection target material. Accordingly, even if there are internal defects or foreign particles in the interior of the inspection target material, the inspection light does not scattered by such internal defects or internal foreign particles. Accordingly, with such an arrangement, the internal defects, the internal foreign particles, or the internal light scattering particles such as internal crystals, do not affect the measurement results. Thus, such an arrangement provides a function of inspecting only the defects and foreign particles on the surface of the inspection target material.

In a second aspect of the method for surface defect detection according to the first aspect of the present invention, the medium layer may be in a liquid state that permits transmission of the inspection light.

In the second aspect, the inspection light propagates through the medium layer. Accordingly, the inspection light and the scattered light such as the total reflected light, the scattered light, etc., can propagate through the medium layer. Furthermore, the medium layer is provided in the liquid state. Thus, the medium layer is provided so as to be in contact with the surface of the inspection target material without a gap. Accordingly, when the inspection light is input from the medium layer side, the inspection light propagating through the medium layer, which has a higher refractive index, toward the inspection target material having a lower refractive index is totally reflected by the interface between the medium layer and the inspection target material.

Furthermore, it is known that it is physically impossible to directly input the inspection light from the air layer side such that it propagates through the medium layer and reaches the inspection target surface of the inspection target material with an incident angle which is equal to or larger than the critical angle. In order to solve this problem, inspection light is preferably introduced into the medium layer using an optical fiber, prism, etc., soaked in the medium layer.

Also, in a case in which the entire area of the inspection target surface of the inspection target material is to be scanned and inspected, there is a need to move the light emission position of the inspection light with respect to the inspection target material. Such an arrangement employing the medium layer in the liquid state allows the entire area of the inspection target surface to be scanned and inspected while adjusting the inspection position without encountering problematic procedures for the light introducing device thus soaked in the medium layer.

The material employed so as to form such a medium layer in a liquid state that permits transmission of the inspection light is not restricted in particular as long as the medium has a higher refractive index than that of the inspection target material. Specific examples of such materials include 1-bromonaphthalene, methylene iodide, cedar oil, liquid paraffin, etc. In particular, among these materials, 1-bromonaphthalene, methylene iodide, and cedar oil are preferably employed since they exhibit a relatively high refractive index.

In a third aspect of the method for surface defect detection according to the first or second aspect of the present invention, the medium layer may have a higher refractive index by at least 0.01 than that of the inspection target material with respect to the wavelength of the inspection light.

The large critical angle leads to a narrow range of the light emission angle permissible for emitting the inspection light, which limits the configuration of the apparatus for achieving the surface defect detection method according to the present invention. Accordingly, the critical angle should be as small as possible. With such an arrangement, the medium layer has a higher refractive index by at least 0.01 than that of the inspection target material, which realizes a sufficiently small critical angle. For example, liquid paraffin having a refractive index n₁ of 1.47 is employed as the medium for quartz glass having a refractive index n₂ of 1.46. In this case, the critical angle θc is around 83.3 degrees, which is obtained as follows. That is to say, θc=sin⁻¹(n₂/n₁)=sin⁻¹(0.993197)=83.3 degrees, which is obtained by solving the Expression sin θc=n₂/n₁.

With such an arrangement, the medium layer has a higher refractive index than that of the inspection target material. Furthermore, the inspection light is input to the inspection target surface with an incident angle which is equal to or greater than the critical angle that achieves total reflection. With such an arrangement, the inspection light does not reach the interior of the inspection target material, and is totally reflected by the inspection target surface. Accordingly, light scattering does not occur due to internal defects, internal foreign particles, or internal light scattering particles such as internal crystals contained in the inspection target material. Thus, such an arrangement provides a function of detecting only the defects and foreign particles on the surface as described above.

In a fourth aspect of the method for surface defect detection according to the first to three aspect of the present invention, the medium layer may be formed of at least one material selected from the group consisting of 1-bromonaphthalene, methylene iodide, cedar oil, and liquid paraffin.

In the fourth aspect, the medium layer formed of such a medium in the liquid state with a thickness of 1 mm has a transmittance of 80% or more, and a relatively high refractive index. With such an arrangement, light over a wide wavelength range, including visible light, can be employed as the inspection light. Furthermore, such materials have a relatively high refractive index. In particular, 1-bromonaphthalene, methylene iodide, and cedar oil have a refractive index of 1.6 or more. That is to say, such materials exhibit a relatively high refractive index. Thus, these materials are most preferably employed as a medium layer in the surface defect detection method for inspecting optical glass, crystallized glass, etc.

In a fifth aspect of the method for surface defect detection according to the first to fourth aspect of the present invention, the reflected light to be detected may be total reflected light of the incident light, which is reflected by the inspection target surface, and a photo-receiving means may be disposed in an optical path of the total reflected light.

In the fifth aspect, the photo-receiving means is disposed on the optical path of the total reflected light such that it can detect the total reflected light of the inspection light, which is reflected by the inspection target surface. Thus, such an arrangement provides a function of inspecting whether or not there are defects or foreign particles on the surface of the inspection target material. That is to say, in a case in which the inspection target material is in the normal state where neither defects nor foreign particles on the surface exist, the incident inspection light is totally reflected by the surface of the inspection target material, thereby achieving total reflected light propagation with substantially the same intensity as that of the inspection light. The total reflected light is detected by the photo-receiving means disposed on the optical path of the total reflected light. On the other hand, in a case in which the inspection target material has defects or foreign particles on the surface, a part of the incident inspection light is scattered by the defects or the foreign particles, which reduces the light intensity of the total reflected light. Thus, such an arrangement detects whether or not there are defects or foreign particles on the surface of the inspection target material based upon the change in the amount of light detected by the photo-receiving means disposed in the optical path of the total reflected light.

In a sixth aspect of the method for surface defect detection according to the first to fifth aspect of the present invention, the reflected light to be detected may be scattered light due to surface defects on the inspection target surface, and a photo-receiving means may be disposed at a position other than in the optical path of the total reflected light.

In the sixth aspect, the scattered light is detected by the photo-receiving means disposed at a position other than in the optical path of the total reflected light, thereby detecting whether or not there are defects or foreign particles on the surface of the inspection target material. More specifically, in a case in which the inspection target material is in the normal state in which there are neither defects nor foreign particles on the surface, the incident inspection light is totally reflected by the surface of the inspection target material, thereby achieving total reflected light propagation of substantially the same amount as that of the inspection light. On the other hand, in a case in which there are defects or foreign particles on the surface of the inspection target material, a portion of the incident inspection light is scattered, thereby generating scattered light propagating in directions in addition to the direction of the optical path of the total reflected light. With such an arrangement, the photo-receiving means is disposed at a position other than in the optical path of the total reflected light. In a case in which there are neither defects nor foreign particles on the surface of the inspection target material, light scattering does not occur, and accordingly, the photo-receiving means detects no light. On the other hand, in a case in which there are defects or foreign particles on the surface of the inspection target material, the photo-receiving means detects the scattered light. Thus, such an arrangement provides a function of detecting whether or not there are defects or foreign particles on the surface of the inspection target material.

In a seventh aspect of the method for surface defect detection according to the first to sixth aspect of the present invention, the inspection target material may be crystallized glass.

The surface defect detection method according to the present invention provides a function of detecting defects or foreign particles on the surface of the inspection target material as described above regardless of whether or not the inspection target material contains internal defects, internal foreign particles, internal scattering particles, etc., even if the inspection target material is a transparent or translucent material. Thus, the surface defect detection method according to the present invention is preferably employed as a surface defect detection method for inspecting transparent materials such as glass substrates, plastic substrates, etc. In particular, the surface defect detection method according to the present invention is preferably employed as a surface defect detection method for detecting defects on the surface of a translucent material such as crystallized glass containing internal crystals, etc.

According to a eighth aspect of the present invention, a surface defect inspection apparatus includes: a medium having a higher refractive index than that of an inspection target material; a medium bath for storing the inspection target material and the medium; a light emitting device which emits inspection light; and a photo-receiving means. With such an arrangement, the light emitting device is disposed to be angle adjustable in order for the inspection light to be totally reflected by the interface between the surface of the inspection target material and the medium layer.

Such an arrangement provides a function of detecting the defects or foreign particles on the surface of the transparent or translucent inspection target material regardless of whether or not the inspection target material contains internal defects, internal foreign particles, or internal light scattering particles such as internal crystals, etc. For example, even if the inspection target material is a transparent material such as an amorphous material, including glass, etc., such an arrangement enables the defects and foreign particles on the surface of the inspection target material to be selectively detected without interference from bubbles, molten residue, etc., contained in the interior of the inspection target material. Furthermore, even if the inspection target material is a translucent material containing internal crystals such as crystallized glass, such an arrangement enables the defects and foreign particles on the surface of the inspection target material to be selectively detected without interference due to the internal crystals, etc.

### EFFECTS OF THE INVENTION

The surface defect detection method according to the present invention provides a function of detecting defects and foreign particles on the surface of a transparent or translucent inspection target material regardless of whether or not the inspection target material contains internal defects, internal foreign particles, or internal light scattering particles such as internal crystals, etc. Even if the inspection target material is a translucent material such as crystallized glass, etc., containing scattering particles such as internal crystals, such an arrangement enables defects on the surface of the inspection target material to be detected. Furthermore, even if the inspection target material is a transparent material such as an amorphous material, including glass, etc., such an arrangement enables the defects and foreign particles on the surface of the inspection target material to be selectively detected without interference from bubbles, molten residue, etc., contained in the interior of the inspection target material. Thus, the surface defect detection method according to the present invention realizes improved performance of the surface defect inspection.

### BRIEF DESCRIPTION OF THE DRAWINGS

FIG. 1 is a schematic diagram showing a surface defect inspection apparatus employing a surface defect detection method according to an embodiment of the present invention;

FIG. 2 is a schematic explanatory diagram showing the optical path for each light according to the present invention, where FIG. 2A shows a case in which there are neither defects nor foreign particles on the surface, and FIG. 2B shows a case in which there are defects or foreign particles on the surface;

FIG. 3 is a schematic diagram showing a surface defect inspection apparatus employing a surface defect detection method according to a second embodiment of the present invention;

FIG. 4 is a schematic diagram showing a surface defect inspection apparatus employing a surface defect detection method according to a third embodiment of the present invention.

### DETAILED DESCRIPTION OF THE INVENTION

In a surface defect detection method according to the present invention, a medium layer, which has a higher refractive index than that of the inspection target material, is provided so as to be in contact with the inspection target surface of the inspection target material. With such an arrangement, inspection light is input to the target surface to be inspected via the medium layer with an incident angle that achieves total reflection. The reflected light, which is generated by reflecting the inspection light by way of the inspection target surface, is detected, thereby detecting the defects and foreign particles on the inspection target surface.

Examples of target materials to be inspected may include: completely transparent materials such as a glass (amorphous) etc.; opaque materials such as a metal, etc.; translucent materials having internal crystals such as a crystallized glass. In particular, the surface defect detection method according to the present invention provides a function of detecting the defects and foreign particles on the surface without interference due to the internal defects, internal foreign particles, internal crystals, etc., contained in the inspection target material. Thus, the surface defect detection method according to the present invention is particularly preferably employed for detecting the defects and the foreign materials on the surface of a completely transparent material such as an optical glass, and the defects and the foreign materials on the surface of a translucent material such as crystallized glass.

A material, which has a higher refractive index by at least 0.01 than that of the target inspection material with respect to the wavelength of the inspection light, is preferably employed as the medium layer used in the surface defect detection method according to the present invention since a small critical angle of total reflection is thereby provided. Furthermore, a material, which has a higher refractive index by at least 0.03 than that of the target inspection material, is more preferably employed as the medium layer. Moreover, a material, which has a higher refractive index by at least 0.05 than that of the target inspection material, is most preferably employed as the medium layer. In addition, a material employed as the medium layer preferably can be provided such that it is in contact with the inspection target surface of the inspection target material. Such a medium layer may be formed of a material in a liquid state, in a paste state, in a gel state, or the like.

For example, in a case in which a material in a liquid state is employed for forming a medium layer having a higher refractive index than that of the inspection target material so to be in contact with the inspection target surface of the inspection target material, the inspection target material is soaked in the medium in the liquid state. Also, examples of the medium layer formation methods include a method in which the surface of the inspection target material is covered with a medium in a liquid state such that it does not escape from the inspection target material, thereby providing the medium layer. It should be noted that a material in a liquid state is preferably employed for forming the medium layer, which provides a simple method with improved workability for providing the medium layer on the surface of the inspection target material without a gap.

The material in a liquid state, which can be employed as the medium, is not restricted in particular as long as the material does not produce adverse effects to the components of the inspection target material, etc. A low-volatility material or a non-volatile materiel is preferably employed. Specific examples of the materials to be employed for forming such a medium layer include 1-bromonaphthalene, methylene iodide, cedar oil, liquid paraffin, etc., which should be employed based upon the refractive index of the inspection target material, etc. In particular, 1-bromonaphthalene and methylene iodide have a higher refractive index than that of “clear serum Z” (trade name), which is a crystallized glass manufactured by Ohara Inc., and “zerodur” (trade name), which is a crystallized glass manufactured by Schott Inc. Accordingly, such materials are preferably employed for detecting the defects and foreign particles on the surface of such crystallized glasses.

As described above, the medium layer is formed with a higher refractive index than that of the inspection target material. With such an arrangement, when the inspection light is input with a larger incident angle than the critical angle that achieves total reflection, the inspection light does not reach the interior of the inspection target material, and the inspection light is totally reflected by the inspection target surface. With such an arrangement, the inspection light does not reach the interior of the inspection target material. Accordingly, with such an arrangement, light scattering does not occur due to the internal defects, internal foreign particles, or internal light-scattering particles such as internal crystals, even if the inspection target material contains the internal defects, internal foreign particles, or internal light-scattering particles. Thus, such an arrangement provides a function of detecting the defects and foreign particles on the surface as described above.

Examples of the inspection light preferably employed include: a slit-shaped beam having a slit-shaped light flux such as a laser light having a predetermined beam diameter; and a slit-shaped beam having a width that corresponds to the width of the inspection target material. With such an arrangement, employing the slit-shaped beam having a slit-shaped light flux such as a laser beam or the like, the incident angle at which the inspection light is emitted from an emitting means to the medium layer can be easily controlled. Furthermore, such an arrangement can be designed such that the photoreceptor face of the photo-receiving means is formed with a reduced area. This suppresses the measurement noise, thereby providing the advantage of reduced measurement error. On the other hand, such an arrangement, which employs the liner light source that emits a slit-shaped beam having a width that corresponds to the width of the inspection target material, provides the advantage of increased inspection speed for scanning and inspecting the entire region of the inspection target surface.

The light emitting device for emitting such a beam is not restricted in particular as long as the light emitting device has a function of emitting light. A suitable device can be selected from among the known light emitting devices according to the purpose. Examples of such light emitting devices include light sources such as a halogen lamp (e.g., xenon lamp), laser light emitting devices, etc.

Also, the slit-shaped light emitting device for emitting a slit-shaped beam having a width that corresponds to the width of the inspection target material may be a light emitting device having a configuration in which multiple narrow optical fibers are bundled together so as to form a light-emitting end in a slit-shaped cross-sectional shape, with the other end of the optical fibers thus bundled being provided near a halogen lamp, mercury lamp, or the like. With such an arrangement, the light emitted from the light source is introduced to the inspection target material through the optical fibers. Also, the slit-shaped light emitting device may be a light emitting device having a configuration in which the light emitted from a light source is introduced to the inspection target material through a single narrow slit. Furthermore, the slit-shaped light emitting device may be a light emitting device having a configuration in which a suitable laser light is widened such that the width thereof matches the width of the inspection target material.

In addition, in order to inspect multiple kinds of inspection target materials having various refractive indices using a medium layer, an angle adjustment mechanism is preferably provided for adjusting the incident angle of the inspection light to be emitted to the target inspection surface.

The photo-receiving means may have a configuration including a commercially-available photoreceptor. Examples of photoreceptor components which can be employed include optical fibers, prisms, elliptic mirrors, lenses, etc., which are used for receiving the reflected light in the medium layer.

The photo-receiving means may be connected to a signal processing unit which outputs detection signals based upon the reflected light detected by the photoreceptor, and an image processing device or the like including a computer or the like for processing the detection signals detected by the photo-receiving means. It should be noted that the number of detection signals (pulses) output from the signal processing unit corresponds to the number of foreign particles or the like. On the other hand, the amplitude of each detection signal corresponds to the size (particle diameter), shape, etc., of the corresponding foreign particle. The detection signals output from the signal processing unit are processed by a microcomputer, upon which the number, the sizes, etc., of the foreign particles are printed or displayed via a printer or a display as necessary.

The image processing device stores beforehand, in a storage unit, the correlation between the output signal, the size (area, length, width, depth) and kind (shape, crack, foreign particle, scratch) of actual defects. The image processing device compares the output signals output from the photo-receiving means or the like and the aforementioned correlation thus stored beforehand, thereby analyzing each defect. Thus, the image processing device provides a function of identifying each defect.

It should be noted that the photo-receiving means such as a photoreceptor, photoreceptor member, or the like, for receiving the reflected light may be provided at a position other than in the optical path of the total reflected light, which allows the scattered light scattered by defects or foreign particles on the surface of the inspection target material to be received, instead of the above-described arrangement in which the photo-receiving means is provided at a position in the optical path of the total reflected light, which allows the total reflected light to be received. Examples of the positions at which the photo-receiving means can be disposed other than in the optical path of the total reflected light include: a position in the medium layer, through which the scattered light propagates, other than in the optical path of the inspection light and the optical path of the total reflected light; and a position in the air outside the medium layer through which the scattered light propagates, i.e., a position in the air above the inspection target surface onto which the inspection light is to be emitted.

With such an arrangement, the photo-receiving means such as a photoreceptor, photoreceptor member, or the like, is disposed in the optical path of the total reflected light. In a case in which any defects or foreign particles on the surface of the inspection target material exist, a portion of the incident inspection light is scattered by way of these defects and foreign particles, leading to a reduction in the amount of the reflected light passing through the optical path of the total reflected light. With such an arrangement, the reduction in the total reflected light is detected, thereby detecting the defects and foreign particles on the surface, and the sizes thereof. On the other hand, with such an arrangement in which the photo-receiving means is disposed at a position other than the optical path of the total reflected light, the scattered light scattered by the defects or foreign particles on the surface is detected, thereby detecting the defects and foreign particles on the surface, and the sizes, etc. thereof.

A detailed description is provided below regarding a surface defect detection method according to an embodiment of the present invention with reference to the drawings. It should be noted that the embodiments described below are merely a listing of specific examples for exemplary purpose only, and it should be clearly understood that the embodiments in no way restrict the technical scope of the present invention.

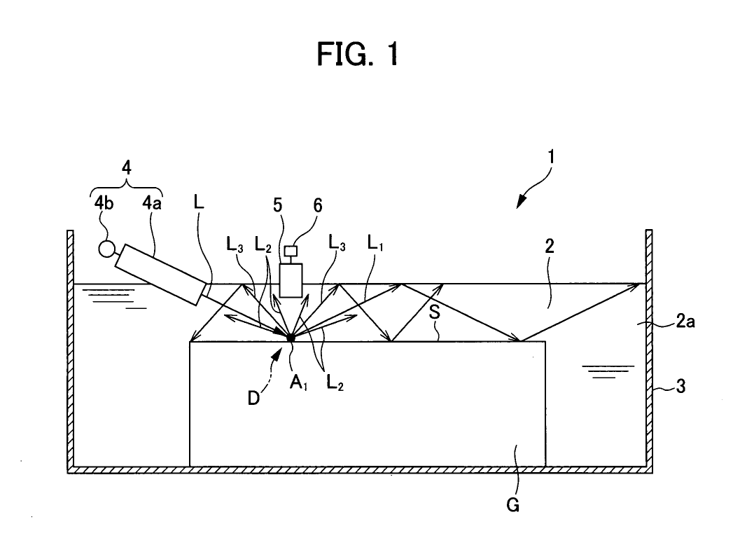

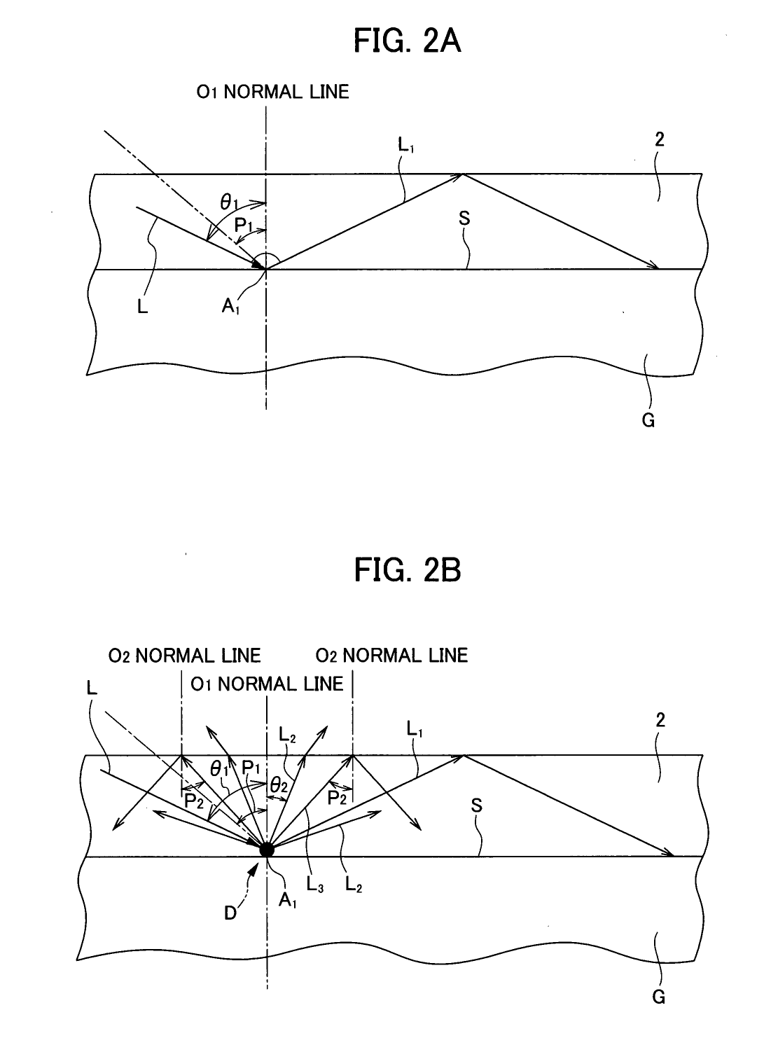

FIG. 1 is a schematic diagram showing a surface defect inspection apparatus using a surface defect detection method according to an embodiment of the present invention. FIG. 2 is a schematic explanatory diagram showing the optical path for each light according to the present invention. More specifically, FIG. 2A shows a case in which there are neither defects nor foreign particles on the surface. FIG. 2B shows a case in which there are defects or foreign particles on the surface.

First, a description is provided regarding the mechanism of the present invention with reference to FIG. 2.

In FIG. 2, the reference character G denotes an inspection target material which is a substrate formed of a transparent material. The reference numeral 2 denotes a medium layer disposed in a predetermined thickness on the inspection target surface S of the inspection target material G such that it is in contact with the inspection target surface S without an air layer therebetween. As the medium layer 2, a medium having a higher refractive index than that of the inspection target material G in a liquid state (e.g., 1-bromonaphthalene), in a paste state, or in a gel state, may be employed.

As shown in FIG. 2A, in a case in which the inspection light L such as laser light or the like is emitted to the position A₁ on the inspection target surface S of the inspection target material G with an incident angle θ₁, which is larger than the total reflection incident angle (which will be referred to as “first critical angle” hereafter) P₁ through the medium layer 2 from a light emitting device including an unshown laser light source or the like, the reference numeral L₁ represents the total reflection light reflected from the position A₁.

The term “first critical angle P₁” represents the smallest angle between the inspection light L and the normal line O₁, which achieves total reflection on the interface between the medium layer 2 having a higher refractive index and the inspection target material G having a lower refractive index than that of the medium layer 2, when the inspection light L is emitted to the inspection target material G through the medium layer 2.

When the inspection light L is input with the incident angle θ₁, which is larger than the first critical angle P₁, the inspection light L is totally reflected, thereby realizing the total reflected light L₁ propagating through the medium layer 2. As a result, there is no light that reaches the interior of the inspection target material G. Next, the total reflected light L₁ is introduced to the interface between the medium layer 2 and the air layer with a larger angle than the critical angle (which will be referred to as “second critical angle P₂” hereafter) that achieves total reflection when the light is emitted from the medium layer 2 to the air layer. This also leads to total reflection on the interface between the medium layer 2 and the air layer. Accordingly, the total reflected light L₁ propagates through the medium layer 2 toward the inspection target surface S of the inspection target material G. Subsequently, the total reflected light L₁ propagating toward the inspection target surface S is input to the interface between the medium layer 2 and the inspection target material G with a larger angle than the first critical angle P₁. Accordingly, the total reflected light L₁ is totally reflected again by the inspection target surface S of the inspection target material G. As described above, the inspection light L input to the inspection target surface S with a larger angle than the first critical angle P₁ propagates through the medium layer 2 while repeatedly totally reflecting (see FIG. 2A).

In a case in which there is a defect or foreign particle D (the same reference character is used for indicating a light scattering factor at a position hereafter for convenience regardless of whether the light scattering factor is a defect or a foreign particle) at the position A₁, a part of the inspection light L is scattered in all directions by the defect or the foreign particle D, thereby generating scattered light L₂ or second total reflected light L₃ (see FIG. 2B). This reduces the amount of the total reflected light L₁. In an arrangement in which an unshown photoreceptor is provided in the optical path of the total reflected light L₁, the change in the amount of the total reflected light L₁ is detected, thereby detecting the defect or the foreign particle D.

A portion of the scattered light L₂ propagates through the medium layer 2 toward the interface between the medium layer 2 and the air layer with a larger scattering angle θ₂ than the second critical angle P₂ (which corresponds to the light L₃). Such scattered light L₂ is totally reflected by the interface between the medium layer 2 and the air layer, following which the scattered light L₂ propagates through the medium layer 2 toward the inspection target material G. On the other hand, the other portion of the scattered light L₂, which propagates through the medium layer 2 toward the interface between the medium layer 2 and the air layer with a smaller scattering angle θ2 than the second critical angle P₂, escapes to the air layer after refraction without total reflection at the interface between the medium layer 2 and the air layer. In an arrangement in which a photoreceptor is disposed at an appropriate position in the air for detecting the scattered light L₂ escaping to the air layer, e.g., at a position between a normal line O₂ and another normal line O₁ with the normal line O₂ introduced therebetween, the scattered light scattered from the defect or foreign particle D is received, thereby detecting the defect or foreign particle D, as shown in FIG. 2B. Here, the term “second critical angle P₂” represents the angle that achieves total reflection when incident light is input to the interface between the medium layer 2 and the air layer through the medium layer 2. Specifically, refractive index of air is equal to approximately 1, which is, in general, far smaller than the refractive index of the inspection target material. Accordingly, in general, the second critical angle P₂ is smaller than the first critical angle P₁. Here, the term “scattering angle θ₂” represents the angle between the scattered light scattered by the defect or foreign particle D (the incident light can be scattered in all directions) and the normal line O₁, as shown in FIG. 2B.

With such an arrangement, the inspection light L is totally reflected by the inspection target surface S of the inspection target material G. Accordingly, there is no component of the inspection light L which reaches the interior of the inspection target material after refraction. Thus, the internal defects and the internal foreign particles are not detected, even if the inspection target material G contains internal defects or internal foreign particles.

Next, a description is provided regarding a surface defect inspection apparatus using the surface defect detection method according to an embodiment of the present invention with reference to FIG. 1.

As shown in FIG. 1, a surface defect inspection apparatus 1 includes: a medium bath 3 for storing a medium 2a having a higher refractive index than that of the inspection target material G; a light emitting means 4 for emitting the inspection light L; and a photo-receiving means 5 for detecting the scattered light L₂ reflected by the inspection target surface S of the inspection target material G. With such an arrangement, the light emitting means 4 includes a light emitting device 4a and a light source 4b. The photo-receiving means 5 includes a photoreceptor having a photoreceptor member and a detecting optical system, which is connected to a signal processing unit 6. The surface defect inspection apparatus 1 has a configuration including a light-emission position adjustment means for allowing the light emitting means 4 and the photo-receiving means 5 to be moved in a horizontal direction, i.e., in forward and backward directions and in left and right directions. Such an arrangement may have a mechanism for allowing the light emitting device 4a and the photo-receiving means 5 mounted on a frame, which is a light-emission position adjustment means, to be moved in a horizontal direction, i.e., in left and right directions, the specific configuration of which is omitted from the drawing. This mechanism allows the inspection target surface S of the inspection target material G to be scanned at a constant scan rate, thereby detecting defects and foreign particles in the entire region of the inspection target surface S. Also, an arrangement may be made in which the light emitting device 4a and the photo-receiving means 5 are maintained in a stationary state, and the inspection target material G is moved in a horizontal direction, i.e., in forward and backward directions and in the left-right direction.

As described above, a material in a liquid state, in a paste state, or in a gel state, which has a higher refractive index by at least 0.01 than that of the target inspection material G, can be employed as the medium 2a to be stored in the medium bath 3. On the other hand, the inspection target material G is disposed in the medium layer 2 stored in the medium bath 3. In this state, the medium layer 2 is provided to be in contact with the surface of the inspection target material G without an air layer therebetween. With the present embodiment, the inspection target material G is provided to be soaked in the medium layer 2. However, the present invention is not restricted to such an arrangement. For example, an arrangement may be made in which a surrounding wall is formed such that it surrounds the edges of the inspection target material G, and the inner space surrounded by the surrounding wall is filled with the medium 2a, thereby forming the medium layer 2.

The light emitting device 4a is connected to the light source 4b such as a laser light source or the like, for example. With such an arrangement, the inspection light L is emitted in the form of a laser beam or a slit-shaped beam. It should be noted that the inspection light L is preferably adjusted such that the beam width matches the width of the inspection target material G. This greatly reduces the operation load of the detector, which scans the entire region of the inspection target surface S of the inspection target material G. Also, the type of the laser light source is not restricted in particular. Examples of the laser light sources which can be employed include gas lasers such as a He—Ne laser etc., semiconductor lasers, and composite element lasers such as a YAG laser.

Furthermore, the light emitting device 4a preferably includes an angle adjustment means for adjusting the incident angle with respect to the inspection target material G according to the critical angle of the total reflection on the interface between the medium layer and the inspection target material thus employed, thereby allowing the incident angle of the inspection light L to be adjusted. Also, with the present invention, there is a relation represented by the Expression (the refractive index of the medium layer 2>the refractive index of the inspection target material G>the refractive index of the air). Accordingly, it is physically impossible to directly introduce the inspection light L via the air to the inspection target surface S of the inspection target material G, i.e., the interface between the medium layer 2 and the inspection target material G with a greater incident angle than the critical angle. In order to solve the aforementioned problem, the inspection light L is introduced to the medium layer 2 using a prism, optical fiber, mirror, etc., as appropriate. It should be noted that the method for introducing the inspection light L is selected as suitable according to the kind of the medium 2a to be used for forming the medium layer 2 and the kind of the inspection target material G. In a case in which the inspection light L is directly introduced into the medium layer 2, a prism or an optical fiber is preferably employed.

The photo-receiving means 5 includes an optical fiber etc., disposed at a position in the medium layer 2, which is above the position A₁ to which the incident inspection light is input. With such an arrangement employing the medium layer 2 in the liquid state, the photo-receiving means 5 is disposed in the medium layer. This prevents fluctuation of the scattered light L₂ received by the photoreceptor even if there is a fluctuation in the surface of the liquid, thereby providing stable photoreception and photodetection. The photo-receiving means 5 is connected to the signal processing unit 6, which is further connected to an unshown image processing apparatus including a computer or the like, which processes the output signals detected by the photo-receiving means. With such an arrangement, the photo-receiving means 5 receives the scattered light L₂, and the signal processing unit 6 detects the scattered light L₂ received by the photo-receiving means 5, thereby outputting the detection signals. Here, the number of the detection signals (pulses) corresponds to the number of foreign particles. On the other hand, the amplitude of each detection signal corresponds to the size (particle diameter), shape, etc., of the corresponding foreign particle. The detection signals are processed by a microcomputer, upon which the number, the sizes, etc., of the foreign particles are printed or displayed via a printer or a display as necessary.

With such an arrangement, the photo-receiving means 5 is disposed at a position in the medium layer 2 such that it is not positioned in the optical path of the total reflected light L₁ of the inspection light L. Also, an arrangement may be made in which the photo-receiving means 5 is disposed at a position near and forward of the position A₁ in the medium layer 2 to which the incident inspection light L is to be input.

It is needless to say that a description has been provided for exemplary purpose only, regarding the light emitting means 4 including the light emitting device 4a, the light source 4b, etc., and the photo-receiving means 5, the signal processing unit 6, etc. The present invention also encompasses an arrangement including other types of light emitting means, photo-receiving means, etc.

With the present embodiment, based upon the above-described inspection mechanism, the photo-receiving means 5 is disposed at a position above or forward of the position A₁ on the inspection target surface S of the inspection target material G, to which the inspection light L is to be input, such that it can detect a defect or foreign particle D at the position A₁, and such that it is not positioned in the optical path of the total reflected light L₁ of the inspection light L in the medium layer 2 provided on the inspection target surface S.

With such an arrangement in which the photo-receiving means 5 is disposed at such a position, the scattered light L₂ is detected due to the defect or foreign particle D on the inspection target surface S of the inspection target material G, thereby detecting the defects and foreign particles on the inspection target surface S.

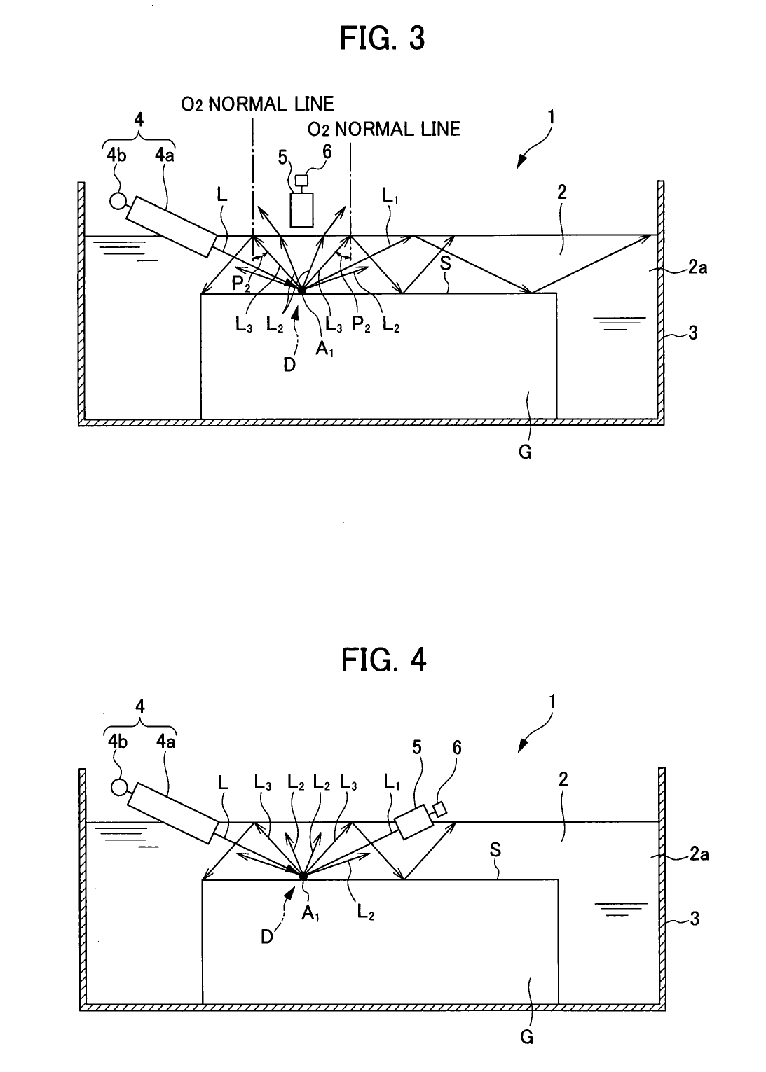

Next, FIG. 3 shows a surface defect inspection apparatus using the surface defect detection method according a second embodiment of the present invention. With the surface defect inspection apparatus 1 shown in FIG. 3, the photo-receiving means 5 is disposed above and outside the medium layer 2 within an angle range smaller than the second critical angle P₂ of the total reflection of the scattered light L₂ (at a position between a normal line O₂ and the another normal line O₂ in FIG. 3), which is a point of difference from the surface defect inspection apparatus shown in FIG. 1. It should be noted that the devices such as the light emitting means 4, the photo-receiving means 5, etc., and the medium layer 2, etc., are the same as those of the first embodiment. Components and the like which are the same as or equivalent to those in the surface defect inspection apparatus according to the first embodiment are denoted by the same reference numerals as those in FIG. 1, and descriptions thereof are omitted.

A description is provided below regarding the operation of the surface defect inspection apparatus according to the second embodiment of the present invention. With such an arrangement, the scattered light L₂ that escapes from the medium layer 2 to the air layer is detected at a position above the position A₁ on the inspection target surface S of the inspection target material G to which the incident inspection light L is input.

In a case in which there are defects or foreign particles D on the inspection target surface S of the inspection target material G, the inspection light L is scattered by the defects or foreign particles D, thereby generating scattered light L₂. As described above, a portion of the scattered light L₂ (scattered light L₂ positioned between the normal lines O₂ and O₂ in FIG. 2B) propagates through the medium layer 2 toward the interface between the medium layer 2 and the air layer at a smaller angle than the second critical angle P₂ that achieves the second total reflected light L₃. Such a portion of the scattered light L₂ escapes to the air layer via the interface between the medium layer 2 and the air layer. With such an arrangement, the photoreceptor 5a is disposed above the medium layer 2 within an angle range smaller than the second critical angle P₂ of the total reflection of the scattered light L₂ (at a position between a normal line O₂ and the another normal line O₂ in FIG. 3), thereby detecting the scattered light L₂ that escapes from the medium layer 2 to the air layer. That is to say, in a case in which there are no defects or foreign particles D on the inspection target surface S of the inspection target material G, no scattered light L₂ is generated, and accordingly, the photo-receiving means 5 receives no light. On the other hand, in a case in which there are defects or foreign particles D, the photo-receiving means 5 receives the scattered light L₂ scattered by the defects or foreign particles D, and the signal processing unit 6 outputs detection signals (pulses) corresponding to the number, sizes (particle diameter), etc., of the foreign particles. The detection signals thus output are processed by a microcomputer, and the number, the size, etc., of the defects are printed or displayed via a printer or a display as necessary. Thus, such an arrangement provides a function of inspecting whether or not there are defects or foreign particles on the surface, etc.

Next, FIG. 4 shows a surface defect inspection apparatus using the surface defect detection method according a third embodiment of the present invention. With the surface defect inspection apparatus 1 shown in FIG. 4, the photo-receiving means 5 is disposed in the medium layer 2 such that it is positioned in the optical path of the total reflected light L₁ of the inspection light L. It should be noted that devices such as the light emitting means 4, the photo-receiving means 5, etc., and the medium layer 2, etc., are the same as those of the first embodiment. Components and the like which are the same as or equivalent to those in the surface defect inspection apparatus according to the first embodiment are denoted by the same reference numerals as those in FIG. 1, and descriptions thereof are omitted.

A description is provided below regarding the operation of the surface defect inspection apparatus according to the third embodiment of the present invention. With such an arrangement, the photo-receiving means 5 is disposed in the medium layer 2 such that it is positioned in the optical path of the total reflected light L₁ of the inspection light L. With such an arrangement, a reduction in the amount of the total reflected light L₁, which is due to scattering occurring at the defects or foreign particles D on the inspection target surface S of the inspection target material G, is detected, thereby detecting the defects and foreign particles D on the inspection target surface S.

In a case in which there are defects or foreign particles D on the inspection target surface S of the inspection target material G, a part of the inspection light L is scattered by the defects or foreign particles D, thereby generating the scattered light L₂ and the second total reflected light L₃. Accordingly, the amount of the total reflected light L₁ thus obtained is smaller than that of the total reflected light L₁ obtained in a case in which there are no defects or foreign particles D. With such an arrangement, the total reflected light L₁ is received by the photo-receiving means 5 disposed in the optical path of the total reflected light L₁, and the signal processing unit 6 outputs detection signals (pulses) corresponding to the number, sizes (particle diameter), etc., of the foreign particles. The detection signals thus output are processed by a microcomputer, and the number, the size, etc., of the foreign particles are printed or displayed via a printer or a display as necessary. Thus, such an arrangement provides a function of inspecting whether or not there are defects or foreign particles on the surface, etc.

1. A surface defect detection method comprising steps of:
providing a medium layer having a higher refractive index than that of an inspection target material such to be in contact with an inspection target surface of the inspection target material;
inputting incident inspection light from the medium layer side with an incident angle that achieves total reflected light propagation through the medium layer; and
detecting reflected light of the inspection light, which is reflected by the inspection target surface, thereby inspecting for surface defects on the inspection target surface.

2. A surface defect detection method according to claim 1, wherein the medium layer is in a liquid state that permits transmission of the inspection light.

3. A surface defect detection method according to claim 1, wherein the medium layer has at least a 0.01 higher refractive index than that of the inspection target material with respect to the wavelength of the inspection light.

4. A surface defect detection method according to claim 1, wherein the medium layer is formed of at least one material selected from the group consisting of 1-bromonaphthalene, methylene iodide, cedar oil, and liquid paraffin.

5. A surface defect detection method according to claim 1, wherein
the reflected light to be detected is total reflected light of the incident light, which is reflected by the inspection target surface,
and a photo-receiving means is disposed in an optical path of the total reflected light.

6. A surface defect detection method according to claim 1, wherein
the reflected light to be detected is scattered light by way of surface defects on the inspection target surface,
and a photo-receiving means is disposed at a position other than in an optical path of the total reflected light.

7. A surface defect detection method according to claim 1, wherein the inspection target material is crystallized glass.

8. A surface defect inspection apparatus comprising:
a medium having a higher refractive index than that of an inspection target material;
a medium bath for storing the inspection target material and the medium;
a light emitting device for emitting inspection light; and
a photo-receiving means,
wherein the light emitting device is disposed to be angle adjustable in order for the inspection light to be totally reflected by the interface between the surface of the inspection target material and the medium layer.
